(19) United States
(12) Patent Application Publication
(10) Pub. No.: US 2010/0106720 A1
(43) Pub. Date: Apr. 29, 2010

(54) METHOD FOR IDENTIFYING A REMOTE PATTERN

(75) Inventors: Kuo-Jen CHAO, Yongkang City (TW); Ching-Chang Lee, Taipel (TW)

Correspondence Address: RABIN & Berdo, PC, 1101 14TH STREET, NW, SUITE 500, WASHINGTON, DC, 20005, US

(73) Assignee: NATIONAL KAOHSIUNG UNIVERSITY OF APPLIED SCIENCES, Kaohsiung City (TW)

(21) Appl. No.: 12/257,392

(22) Filed: Oct. 24, 2008

(51) Int. Cl. G06F 17/30; H04N 5/225; H04N 1/00

(52) U.S. Cl. 707/728; 348/207.1; 358/403; 348/E05.001; 707/E17.001

(57) ABSTRACT

For clearly identifying a product recorded in an image file provided by a client terminal, a method for identifying a remote pattern method is provided for preventing disputes between consumers and shopping websites. Such disputes are often caused when a conventional shopping website just searches products required by a consumer based on messages provided by the consumer. In the provided method, an image file of a required product of a consumer is identified by a customer service terminal for generating a plurality of keywords related to the required product. The keywords are then inputted into a database for searching. Detailed information about the required product is found according to search results. After the detailed information is examined by the customer service terminal, the examined detailed information is returned to the client at the client terminal.

### BACKGROUND OF THE INVENTION

1. Field of the Invention

The present invention relates to a method for identifying a remote pattern, and more particularly to a method for identifying a remote pattern of a required product using keywords correlated to the required product.

2. Description of Related Art

When purchasing goods from remote location, such as stores or website, consumers acquired a catalog provided by a merchant to obtain complete information about the products and refer to the catalog to pick and order desired products. However, as the development of information technologies, shopping channels gradually replace catalog-based consumption model. Consumers can easily obtain most information about interested products through introduction of the shopping channels, and directly dial a special phone number to order the products with a remote customer service representatives. Such a telecommunication may be complex and easily leads to shopping disputes if the consumers cannot precisely express, or the customer service representatives misunderstand the consumers' meaning.

To overcome the shortcomings, the present invention provides a method for identifying a remote pattern to mitigate or obviate the aforementioned problems.

### SUMMARY OF THE INVENTION

The main objective of the present invention is to provide a method for identifying a remote pattern of a required product of a consumer for eliminating disputes between consumers and sellers.

The method includes the acts of receiving an image file of a product uploaded from a client terminal, transmitting the image file to a customer service terminal to generate keywords, searching a database with the keywords to obtain preliminary identifying results, transmitting the preliminary identifying results to a customer service terminal to generate latter identifying results, and sending the latter identifying results to the client terminal.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a system implementing a method for identifying a remote pattern in accordance with the present invention; and

FIG. 2 is a flow chart of the method in accordance with the present invention.

### DETAILED DESCRIPTION OF THE PREFERRED EMBODIMENT

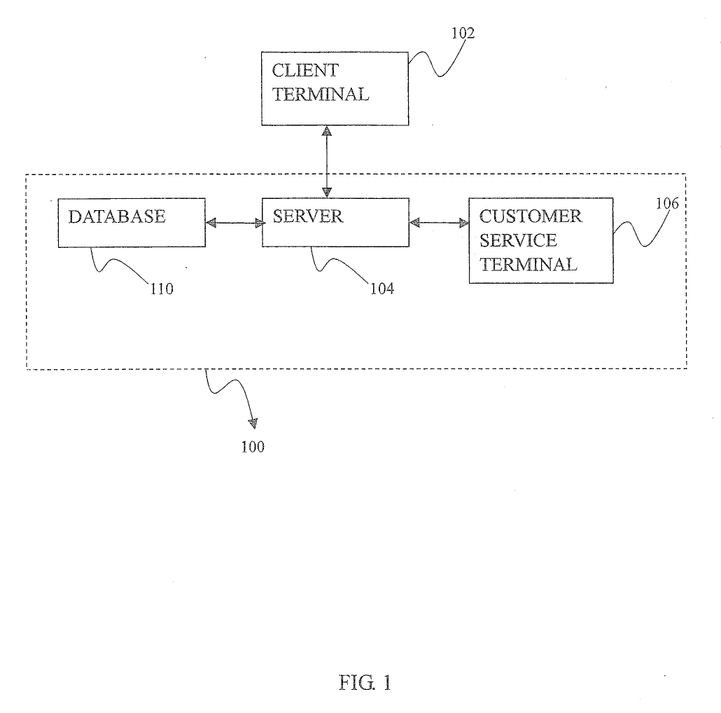

With reference to FIG. 1, an image identifying system (100) for implementing the method in accordance with the present invention is capable of connecting to a client terminal (102) and includes a server (104), a customer service terminal (106) and a database (110). The image identifying system (100) may receive an image file provided by consumers from the client terminal (102), transmit the image file to the customer service terminal (106) for identifying a product recorded in the image file, and returning the identified result of the image file to the client terminal (102).

For example, when the method is applied to a shopping website, the image identifying system (100) is available on the shopping website and the image file can be a picture of a required product that consumers intend to purchase. The image file can be created through many different ways. The consumers can use a photographic device such as but not limited to a digital camera, a cell phone or web-cam to take the image of the required product, capture the image from a website, scan the image from a photo or drawn picture or like to generate the image.

The server (104) receives the image file from the client terminal (102), transmits the image file to the customer service terminal (106), receives keywords for identifying from the customer service terminal (106), uses the keywords to search the database (110) for generating preliminary identifying results, returns the preliminary identifying results to the customer service terminal (106) to generate latter identifying results, and transmits the latter identifying result to the client terminal (102).

The database (110) stores product information and is accessible by the server (104). The server (104) searches the database (110) with the keywords to find matched results correlating to the required product. These matched results are regarded as preliminary identifying results and may correlate differently to the required product.

The customer service terminal (106) takes the image file provided by the client terminal (102) to accordingly provide multiple keywords for searching processes in the database (110). The customer service terminal (106) examines the preliminary identifying results to determine what should be retained or not and may further sort the preliminary identifying results according to their correlation to generate the latter identifying results to be transmitted to the client terminal through the server (104).

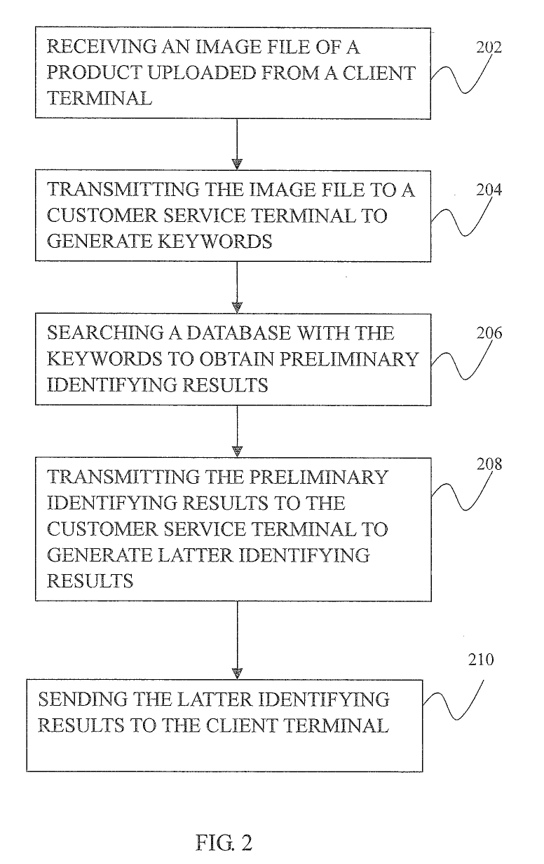

With further reference to FIG. 2, a method for identifying a remote pattern in accordance with the present invention comprises the acts of receiving an image file of a product uploaded from a client terminal (202), transmitting the image file to a customer service terminal to generate keywords (204), searching a database with the keywords to obtain preliminary identifying results (206), transmitting the preliminary identifying results to the customer service terminal to generate latter identifying results (208) and sending the latter identifying results to the client terminal (210).

In the act of receiving an image file of a product (202), the server (104) of the image identifying system (100) receives the image file of a required product transmitted from the client terminal (102).

In the act of transmitting the image file to the customer service terminal (204), the server (104) sends the image file to the customer service terminal (106). The customer service terminal (106) identifies the image file and accordingly provides multiple keywords related to the image file.

In the act of searching a database with the keywords to obtain preliminary identifying results (206), the sever (104) receives the keywords from the customer service terminal (106) and utilizes these keywords to search the database (110). Based on the keywords, multiple searching results may be obtained as preliminary identifying results. These preliminary identifying results may correlate differently to the required product.

In the act of transmitting the preliminary identifying results to the customer service terminal to generate latter identifying results (208), the server (104) receives and sends the preliminary identifying results to the customer service terminal (106). The customer service terminal (106) examines the preliminary identifying results in order to determine what should be retained or not and may further sort the preliminary identifying results according to their correlation to generate the latter identifying results.

In the act of sending the latter identifying results to the client terminal (210), the customer service terminal (106) transmits the latter identifying results through the server (104) to the client terminal (102) so the consumers at the client terminal (102) can check the latter identifying results. If the latter identifying results indeed comprise and meet the required product, consumers at the client terminal (102) can send a confirm message to the server (104) to purchase the required product.

With the method for identifying a remote pattern, a much simpler and easier shopping mode for consumers is achieved. The consumers need directly communicate the customer service representatives using complex speech, but can “show” pictures. Further, shopping disputes resulting from consumers imprecisely expressing or customer service representatives misunderstanding the consumers' meaning can be mitigated.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for identifying a remote pattern comprising the acts of:
receiving an image file of a product uploaded from a client terminal;
transmitting the image file to a customer service terminal for generating multiple keywords;
searching a database with the keywords to obtain preliminary identifying results;
transmitting the preliminary identifying results to the customer service terminal to generate latter identifying results; and
sending the latter identifying results to the client terminal.

2. The method as claimed in claim 1, wherein the image file is generated by capturing an image from a website.

3. The method as claimed in claim 1, wherein the image file is generated by taking a picture using a photographic device.

4. The method as claimed in claim 3, wherein the photographic device is selected from the group consisting of a digital camera, a cell phone and a web-cam.

5. The method as claimed in claim 1, wherein the image file is generated by scanning an image.
